(19) United States
(12) Patent Application Publication
(10) Pub. No.: US 2012/0199692 A1
(43) Pub. Date: Aug. 9, 2012

(54) REACTIVE DRIVE ROTOR HEAD WITH EXTERNAL SWASHPLATE

(75) Inventor: Jacob Johannes van der Westhuizen, South Jordan, UT (US)

(73) Assignee: GROEN BROTHERS AVIATION, INC, Salt Lake City, UT (US)

(21) Appl. No.: 13/433,427

(22) Filed: Mar. 29, 2012

Related U.S. Application Data
(63) Continuation-in-part of application No. 13/199,671, filed on Sep. 7, 2011.
Application No. 13/199,671 is a continuation-in-part of application No. 13/199,684, filed on Sep. 7, 2011.
Application No. 13/199,684 is a continuation-in-part of application No. 13/199,678, filed on Sep. 7, 2011.
Application No. 13/199,678 is a continuation-in-part of application No. 13/199,682, filed on Sep. 7, 2011.
Application No. 13/199,682 is a continuation-in-part of application No. 13/199,681, filed on Sep. 7, 2011.
Application No. 13/199,681 is a continuation-in-part of application No. 13/199,677, filed on Sep. 7, 2011.
Application No. 13/199,677 is a continuation-in-part of application No. 13/199,679, filed on Sep. 7, 2011.
Application No. 13/199,679 is a continuation-in-part of application No. 13/199,720, filed on Sep. 7, 2011.
Application No. 13/199,720 is a continuation-in-part of application No. 13/373,439, filed on Nov. 14, 2011.
Application No. 13/373,439 is a continuation-in-part of application No. 13/199,719, filed on Sep. 7, 2011.
Application No. 13/199,719 is a continuation-in-part of application No. 13/199,721, filed on Sep. 7, 2011.
Application No. 13/199,721 is a continuation-in-part of application No. 13/199,705, filed on Sep. 7, 2011.
Application No. 13/199,705 is a continuation-in-part of application No. 13/282,749, filed on Oct. 27, 2011.
Application No. 13/282,749 is a continuation-in-part of application No. 13/199,712, filed on Sep. 7, 2011.
Application No. 13/199,712 is a continuation-in-part of application No. 13/282,780, filed on Oct. 27, 2011.
Application No. 13/282,780 is a continuation-in-part of application No. 13/282,815, filed on Oct. 27, 2011.
Application No. 13/282,815 is a continuation-in-part of application No. 13/282,877, filed on Oct. 27, 2011.
Application No. 13/282,877 is a continuation-in-part of application No. 13/282,938, filed on Oct. 27, 2011.
Application No. 13/282,938 is a continuation-in-part of application No. 13/373,406, filed on Nov. 14, 2011.
Application No. 13/373,406 is a continuation-in-part of application No. 13/283,461, filed on Oct. 27, 2011.
Application No. 13/283,461 is a continuation-in-part of application No. 13/282,985, filed on Oct. 27, 2011.
Application No. 13/282,985 is a continuation-in-part of application No. 13/317,749, filed on Oct. 27, 2011.
Application No. 13/317,749 is a continuation-in-part of application No. 13/317,750, filed on Oct. 27, 2011.
Application No. 13/317,750 is a continuation-in-part of application No. 13/317,751, filed on Oct. 27, 2011.
Application No. 13/317,751 is a continuation-in-part of application No. 13/373,421, filed on Nov. 14, 2011.
Application No. 13/373,421 is a continuation-in-part of application No. 13/373,433, filed on Nov. 14, 2011.
Application No. 13/373,433 is a continuation-in-part of application No. 13/373,413, filed on Nov. 14, 2011.
Application No. 13/373,413 is a continuation-in-part of application No. 13/373,440, filed on Nov. 14, 2011.
Application No. 13/373,440 is a continuation-in-part of application No. 13/334,261, filed on Dec. 22, 2011.
Application No. 13/334,261 is a continuation-in-part of application No. 13/335,541, filed on Dec. 22, 2011.
Application No. 13/335,541 is a continuation-in-part of application No. 13/373,414, filed on Nov. 14, 2011.
Application No. 13/373,414 is a continuation-in-part of application No. 13/373,412, filed on Nov. 14, 2011.
Application No. 13/373,412 is a continuation-in-part of application No. 13/373,420, filed on Nov. 14, 2011.
Application No. 13/373,420 is a continuation-in-part of application No. 13/349,201, filed on Jan. 12, 2012.
Application No. 13/349,201 is a continuation-in-part of application No. 13/427,696, filed on Mar. 22, 2012.
(60) Provisional application No. 61/381,291, filed on Sep. 9, 2010.
(60) Provisional application No. 61/403,099, filed on Sep. 9, 2010.
(60) Provisional application No. 61/403,097, filed on Sep. 9, 2010.
(60) Provisional application No. 61/381,313, filed on Sep. 9, 2010.
(60) Provisional application No. 61/403,111, filed on Sep. 9, 2010.
(60) Provisional application No. 61/381,347, filed on Sep. 9, 2010.
(60) Provisional application No. 61/403,136, filed on Sep. 9, 2010.
(60) Provisional application No. 61/403,134, filed on Sep. 9, 2010.
(60) Provisional application No. 61/460,572, filed on Jan. 3, 2011.
(60) Provisional application No. 61/403,098, filed on Sep. 9, 2010.
(60) Provisional application No. 61/403,081, filed on Sep. 9, 2010.
(60) Provisional application No. 61/403,135, filed on Sep. 9, 2010.
(60) Provisional application No. 61/409,475, filed on Nov. 2, 2010.
(60) Provisional application No. 61/403,113, filed on Sep. 9, 2010.
(60) Provisional application No. 61/409,478, filed on Nov. 2, 2010.
(60) Provisional application No. 61/409,476, filed on Nov. 2, 2010.
(60) Provisional application No. 61/409,482, filed on Nov. 2, 2010.
(60) Provisional application No. 61/409,470, filed on Nov. 2, 2010.
(60) Provisional application No. 61/517,413, filed on Apr. 19, 2011.
(60) Provisional application No. 61/468,964, filed on Mar. 29, 2011.
(60) Provisional application No. 61/409,487, filed on Nov. 2, 2010.
(60) Provisional application No. 61/409,494, filed on Nov. 2, 2010.
(60) Provisional application No. 61/456,219, filed on Nov. 2, 2010.
(60) Provisional application No. 61/456,221, filed on Nov. 2, 2010.
(60) Provisional application No. 61/456,220, filed on Nov. 2, 2010.
(60) Provisional application No. 61/506,572, filed on Jul. 11, 2011.
(60) Provisional application No. 61/519,075, filed on May 16, 2011.
(60) Provisional application No. 61/519,055, filed on May 16, 2011.
(60) Provisional application No. 61/460,573, filed on Jan. 4, 2011.
(60) Provisional application No. 61/461,223, filed on Jan. 13, 2011.
(60) Provisional application No. 61/429,282, filed on Jan. 3, 2011.
(60) Provisional application No. 61/429,289, filed on Jan. 3, 2011.
(60) Provisional application No. 61/575,196, filed on Aug. 17, 2011.
(60) Provisional application No. 61/499,996, filed on Jun. 22, 2011.
(60) Provisional application No. 61/575,204, filed on Aug. 18, 2011.
(60) Provisional application No. 61/532,233, filed on Sep. 8, 2011.
(60) Provisional application No. 61/539,668, filed on Sep. 27, 2011.
(60) Provisional application No. 61/626,783, filed on Oct. 3, 2011.
(60) Provisional application No. 61/432,488, filed on Jan. 13, 2011.
(60) Provisional application No. 61/466,177, filed on Mar. 22, 2011.

(51) Int. Cl. B64C 27/605; B64C 27/06; B23P 11/00

(52) U.S. Cl. 244/17.25; 29/889

(57) ABSTRACT

A rotorcraft is disclosed. The rotorcraft may include an airframe comprising a mast defining an interior cavity, at least one compressor connected to the airframe, and a rotor. The rotor may include a hub and a rotor blade. The hub may connect to the mast to rotate with respect thereto. The hub may also define an interior cavity. The rotor blade may form a radial conduit extending radially therewithin. A flow of compressed air generated by the at least one compressor may pass from the at least one compressor, through the interior cavity defined by the mast, through the interior cavity defined by the hub, and into the radial conduit. A swashplate assembly controlling pitch of the rotor blade may be located exterior to the hub and mast. Accordingly, the swashplate assembly may not be heated by the flow of compressed air.

### RELATED APPLICATIONS

This application claims the benefit of co-pending U.S. Provisional Patent Application Ser. No. 61/468,964, filed on Mar. 29, 2011, co-pending U.S. Provisional Patent Application Ser. No. 61/506,572, filed on Jul. 11, 2011, co-pending U.S. Provisional Patent Application Ser. No. 61/499,996, filed on Jun. 22, 2011, co-pending U.S. Provisional Patent Application Ser. No. 61/532,233, filed on Sep. 8, 2011, co-pending U.S. Provisional Patent Application Ser. No. 61/539,668, filed on Sep. 27, 2011; and is a continuation-in-part of co-pending U.S. patent application Ser. No. 13/199,671, filed on Sep. 7, 2011, which claims the benefit of U.S. Provisional Patent Application Ser. No. 61/381,291, filed on Sep. 9, 2010, co-pending U.S. patent application Ser. No. 13/199,684, filed on Sep. 7, 2011, which claims the benefit of U.S. Provisional Patent Application Ser. No. 61/403,099, filed on Sep. 9, 2010, co-pending U.S. patent application Ser. No. 13/199,678, filed on Sep. 7, 2011, which claims the benefit of U.S. Provisional Patent Application Ser. No. 61/403,097, filed on Sep. 9, 2010, co-pending U.S. patent application Ser. No. 13/199,682, filed on Sep. 7, 2011, which claims the benefit of U.S. Provisional Patent Application Ser. No. 61/381,313, filed on Sep. 9, 2010, co-pending U.S. patent application Ser. No. 13/199,681, filed on Sep. 7, 2011, which claims the benefit of U.S. Provisional Patent Application Ser. No. 61/403,111, filed on Sep. 9, 2010, co-pending U.S. patent application Ser. No. 13/199,677, filed on Sep. 7, 2011, which claims the benefit of U.S. Provisional Patent Application Ser. No. 61/381,347, filed on Sep. 9, 2010, co-pending U.S. patent application Ser. No. 13/199,679, filed on Sep. 7, 2011, which claims the benefit of U.S. Provisional Patent Application Ser. No. 61/403,136, filed on Sep. 9, 2010, co-pending U.S. patent application Ser. No. 13/199,720, filed on Sep. 7, 2011, which claims the benefit of U.S. Provisional Patent Application Ser. No. 61/403,134, filed on Sep. 9, 2010, co-pending U.S. patent application Ser. No. 13/373,439, filed on Nov. 14, 2011, which claims the benefit of U.S. Provisional Patent Application Ser. No. 61/460,572, filed on Jan. 3, 2011, co-pending U.S. patent application Ser. No. 13/199,719, filed on Sep. 7, 2011, which claims the benefit of U.S. Provisional Patent Application Ser. No. 61/403,098, filed on Sep. 9, 2010, co-pending U.S. patent application Ser. No. 13/199,721, filed on Sep. 7, 2011, which claims the benefit of U.S. Provisional Patent Application Ser. No. 61/403,081, filed on Sep. 9, 2010, co-pending U.S. patent application Ser. No. 13/199,705, filed on Sep. 7, 2011, which claims the benefit of U.S. Provisional Patent Application Ser. No. 61/403,135, filed on Sep. 9, 2010, co-pending U.S. patent application Ser. No. 13/427,696, filed on Mar. 22, 2012, which claims the benefit of U.S. Provisional Patent Application Ser. No. 61/466,177, filed on Mar. 22, 2011, co-pending U.S. patent application Ser. No. 13/282,749, filed on Oct. 27, 2011, which claims the benefit of U.S. Provisional Patent Application Ser. No. 61/409,475, filed on Nov. 2, 2010, co-pending U.S. patent application Ser. No. 13/199,712, filed on Sep. 7, 2011, which claims the benefit of U.S. Provisional Patent Application Ser. No. 61/403,113, filed on Sep. 9, 2010, co-pending U.S. patent application Ser. No. 13/282,780, filed on Oct. 27, 2011, which claims the benefit of U.S. Provisional Patent Application Ser. No. 61/409,478, filed on Nov. 2, 2010, co-pending U.S. patent application Ser. No. 13/282,815, filed on Oct. 27, 2011, which claims the benefit of U.S. Provisional Patent Application Ser. No. 61/409,476, filed on Nov. 2, 2010, co-pending U.S. patent application Ser. No. 13/282,877, filed on Oct. 27, 2011, which claims the benefit of U.S. Provisional Patent Application Ser. No. 61/409,482, filed on Nov. 2, 2010, co-pending U.S. patent application Ser. No. 13/282,938, filed on Oct. 27, 2011, which claims the benefit of U.S. Provisional Patent Application Ser. No. 61/409,470, filed on Nov. 2, 2010, co-pending U.S. patent application Ser. No. 13/373,406, filed on Nov. 14, 2011, which claims the benefit of U.S. Provisional Patent Application Ser. No. 61/517,413, filed on Apr. 19, 2011, co-pending U.S. patent application Ser. No. 13/283,461, filed on Oct. 27, 2011, which claims the benefit of U.S. Provisional Patent Application Ser. No. 61/409,487, filed on Nov. 2, 2010, co-pending U.S. patent application Ser. No. 13/282,985, filed on Oct. 27, 2011, which claims the benefit of U.S. Provisional Patent Application Ser. No. 61/409,494, filed on Nov. 2, 2010, co-pending U.S. patent application Ser. No. 13/317,749, filed on Oct. 27, 2011, which claims the benefit of U.S. Provisional Patent Application Ser. No. 61/456,219, filed on Nov. 2, 2010, co-pending U.S. patent application Ser. No. 13/317,750, filed on Oct. 27, 2011, which claims the benefit of U.S. Provisional Patent Application Ser. No. 61/456,221, filed on Nov. 2, 2010, co-pending U.S. patent application Ser. No. 13/317,751, filed on Oct. 27, 2011, which claims the benefit of U.S. Provisional Patent Application Ser. No. 61/456,220, filed on Nov. 2, 2010, co-pending U.S. patent application Ser. No. 13/349,201, filed on Jan. 12, 2012, which claims the benefit of U.S. Provisional Patent Application Serial No. 61/432,488, filed on Jan. 13, 2011, co-pending U.S. patent application Ser. No. 13/373,421, filed on Nov. 14, 2011, which claims the benefit of U.S. Provisional Patent Application Ser. No. 61/519,075, filed on May 16, 2011, co-pending U.S. patent application Ser. No. 13/373,433, filed on Nov. 14, 2011, which claims the benefit of U.S. Provisional Patent Application Ser. No. 61/519,055, filed on Aug. 22, 2011, co-pending U.S. patent application Ser. No. 13/373,413, filed on Nov. 14, 2011, which claims the benefit of U.S. Provisional Patent Application Ser. No. 61/460,573, filed on Jan. 4, 2011, co-pending U.S. patent application Ser. No. 13/373,440, filed on Nov. 14, 2011, which claims the benefit of U.S. Provisional Patent Application Ser. No. 61/461,223, filed on Jan. 13, 2011, co-pending U.S. patent application Ser. No. 13/334,261, filed on Dec. 22, 2011, which claims the benefit of U.S. Provisional Patent Application Ser. No. 61/429,282, filed on Jan. 3, 2011, co-pending U.S. patent application Ser. No. 13/335,541, filed on Dec. 22, 2011, which claims the benefit of U.S. Provisional Patent Application Ser. No. 61/429,289, filed on Jan. 3, 2011, co-pending U.S. patent application Ser. No. 13/373,414, filed on Nov. 14, 2011, which claims the benefit of U.S. Provisional Patent Application Ser. No. 61/575,196, filed on Aug. 17, 2011, co-pending U.S. patent application Ser. No. 13/373,412, filed on Nov. 14, 2011, which claims the benefit of U.S. Provisional Patent Application Ser. No. 61/575,204, filed on Aug. 17, 2011, and co-pending U.S. patent application Ser. No. 13/373,420, filed on Nov. 14, 2011, which claims the benefit of U.S. Provisional Patent Application Ser. No. 61/626,783, filed on Oct. 3, 2011, all of which are hereby incorporated by reference.

Additionally, this patent application hereby incorporates by reference U.S. Pat. No. 5,301,900 issued Apr. 12, 1994 to Groen et al., U.S. Pat. No. 1,947,901 issued Feb. 20, 1934 to J. De la Cierva, and U.S. Pat. No. 2,352,342 issued Jun. 27, 1944 to H. F. Pitcairn.

### BACKGROUND

1. The Field of the Invention

This invention relates to rotating wing aircraft (rotorcraft), and, more particularly to rotorcraft relying on autorotation of a rotor to provide lift.

2. The Background Art

Rotorcraft rely on a rotating wing to provide lift. In contrast, fixed-wing aircraft rely on air flow over a fixed wing to provide lift. Fixed-wing aircraft must therefore achieve a minimum ground velocity on takeoff before the lift on the wing is sufficient to overcome the weight of the plane. Fixed-wing aircraft therefore generally require a long runway along which to accelerate to achieve this minimum velocity and takeoff.

In contrast, rotorcraft can take off and land vertically or along short runways inasmuch as powered rotation of the rotating wing provides the needed lift. This makes rotorcraft particularly useful for landing in urban locations or undeveloped areas without a proper runway.

The most common rotorcraft in use today are helicopters. A helicopter typically includes an airframe, housing an engine and passenger compartment, and a rotor, driven by the engine, to provide lift. Forced rotation of the rotor causes a reactive torque on the airframe. Accordingly, conventional helicopters require either two counter rotating rotors or a tail rotor in order to counteract this reactive torque.

Another type of rotorcraft is the autogyro. An autogyro aircraft derives lift from an unpowered, freely rotating rotor comprising two or more rotor blades. The energy to rotate the rotor results from a windmill-like effect of air passing through the underside of the rotor (i.e., autorotation of the rotor). The Bernoulli effect of the airflow moving over the rotor blade surface creates lift. The forward movement of the aircraft comes in response to a thrusting engine such as a motor driven propeller mounted fore or aft.

During the early years of aviation, autogyro aircraft were proposed to avoid the problem of aircraft stalling in flight and to reduce the need for runways. In autogyro aircraft, the relative airspeed of the rotor blades may be controlled or influenced somewhat independent of the forward airspeed of the autogyro, allowing slow ground speed for takeoff and landing, and safety in slow-speed flight.

Various autogyro devices in the past have provided some means to begin rotation of the rotor prior to takeoff (i.e., prerotation). Prerotation may minimize the takeoff distance down a runway. One type of autogyro is the “gyrodyne.” Examples of such aircraft are the XV-1 convertiplane tested in 1954 and the Rotodyne built by Fairey Aviation in 1962. The gyrodyne includes a thrust source providing thrust in a flight direction and a rotor providing autorotative lift at cruising speeds. Jet engines located on the tip of each rotor blade provided rotation of the rotor during takeoff, landing, and hovering.

Although typical rotorcraft provide the significant advantage of vertical takeoff and landing (VTOL), they are much more limited in their maximum flight speed than are fixed-wing aircraft. One reason that prior rotorcraft are unable to achieve high flight speed is a phenomenon known as “retreating blade stall.”

In a fixed-wing aircraft, all wings move forward in fixed relation with respect to one another and the airframe. However, as a rotorcraft moves in a flight direction, rotation of the rotor causes each blade thereof to be either “advancing” or “retreating.” A blade is advancing if it is moving in the same direction as the flight direction. A blade is retreating if it is moving opposite the flight direction. Thus, the velocity of any point on any blade is the velocity of that point, with respect to the airframe, plus the velocity of the airframe.

Rotor blades are airfoils that provide lift based on the speed of air flow thereover. Accordingly, the advancing blade typically experiences much greater lift than the retreating blade. If left unchecked, this disproportionate lift may render the rotorcraft unflyable. One solution to this problem is allowing the rotor blades to “flap.” Flapping enables rotorcraft to travel in a direction substantially perpendicular to the axis of rotation of the rotor.

With flapping, an advancing blade is allowed to fly or flap upward in response to the increased air speed thereover, thereby reducing the blade's angle of attack. This, in turn, reduces the lift generated by the advancing blade. A retreating blade experiences less air speed and tends to fly or flap downward such that its angle of attack is increased. This, in turn, increases the lift generated by the retreating blade. In this manner, flapping balances the lift generated by the advancing and retreating blades.

However, lift equalization due to flapping is limited by retreating blade stall. As noted above, flapping of the rotor blades increases the angle of attack of the retreating blade. At certain higher speeds in the direction of flight, the increase in the blade angle of attack required to equalize lift results in loss of lift (stalling) of the retreating blade.

A second limit on the speed of rotorcraft is the drag at the tips of the rotor blades. The tip of the advancing blade is moving at a speed equal to the speed of the aircraft relative to the surrounding air, plus the speed of the tip of the blade with respect to the aircraft. Thus, the speed at the tip of an advancing blade is equal to the sum of the flight speed of the rotorcraft plus the product of the length of the blade and the angular velocity of the rotor.

In helicopters, the rotor must rotate to provide both upward lift and thrust in the direction of flight. Increasing the speed of a helicopter increases the air speed at the tip, both because of the increased flight speed as well as the increased angular velocity of the rotors required to provide supporting thrust. The speed at the tip of the advancing blade could therefore approach the speed of sound, even when the flight speed of the rotorcraft is actually much less. As the air speed over the tip approaches the speed of sound, the drag on the blade becomes greater than the engine can overcome. Accordingly, helicopters are quite limited in how fast they can fly.

In autogyro aircraft, the tips of the advancing blades are also subject to this increased drag, even for flight speeds much lower than the speed of sound. The tip speed for an autogyro is typically smaller than that of a helicopter, for a given airspeed, since the rotor is not driven. Nevertheless, the same drag increase occurs eventually.

A third limit on the speed of rotorcraft is reverse air flow over the retreating blade. As noted above, the retreating blade is traveling opposite the flight direction with respect to the airframe. At certain high speeds in the direction of flight, portions of the retreating blade may move rearward, with respect to the airframe, slower than the flight speed of the airframe. Accordingly, the direction of air flow over those portions of the retreating blade is reversed from that typically designed to generate positive lift.

Rather then generating positive lift, reverse air flow may impose negative lift, or a downward force, on the retreating blade. That is, an airfoil with positive angle of attack in a first direction has a negative angle of attack in a second direction, opposite the first direction.

The ratio of air speed of a rotorcraft in the direction of flight to the maximum corresponding air speed at the tips of the rotor blades is known as the “advance ratio.” The maximum advance ratio of currently available rotorcraft is less than 0.5. For most helicopters, the maximum achievable advance ratio is between about 0.3 and 0.4. Accordingly, current rotorcraft are limited to a top flight speed of about 200 miles per hour (mph) or less.

The rotor or rotors of an autogyro aircraft may be prerotated prior to starting a running take-off, ultra-short take-off, or jump take-off. Selected autogyro aircraft currently available have mechanical, electrical, or hydraulic prerotation systems. The mechanical prerotation systems are typically engine driven. They usually consist of a drive belt transferring power from an engine to a pulley mounted on a friction clutch. The friction clutch is typically connected to a drive shaft, which drives another clutch mechanism connected to the rotor head or hub.

Mechanical prerotation systems may include interlocks that disengage the prerotation system as soon as collective is pulled and the autogyro aircraft becomes light on its wheels. Experimental autogyro aircraft do not typically have these interlocks and rely on the pilot to release the clutch before take-off.

Electrical prerotation systems typically consist of an electrical power source like a generator driven by the engine and an electric motor driving the rotor. The electric motor may engage the rotor via a clutch that disengages after prerotation, leaving the rotor free to autorotate without any drag from the prerotation system. Electrical prerotation systems tend to be comparatively heavy and are mostly used on small “experimental” autogyro aircraft.

Hydraulic prerotation systems typically consist of an engine driven pump connected to a hydraulic motor driving the rotor. Similar to electrical prerotation systems, the hydraulic motor may engage the rotor via a clutch that disengages after prerotation, leaving the rotor free to autorotate without any drag from the prerotation system.

In view of the foregoing, what is needed is an improved apparatus and method for prerotation that is simple, has fewer parts than conventional prerotation systems, and is easier to maintain. A rotor head supporting delivery of compressed air to the rotor blades is further needed.

### BRIEF SUMMARY OF THE INVENTION

The invention has been developed in response to the present state of the art and, in particular, in response to the problems and needs in the art that have not yet been fully solved by currently available apparatus and methods. The features and advantages of the invention will become more fully apparent from the following description and appended claims, or may be learned by practice of the invention as set forth hereinafter.

Gyrodynes may be defined as rotorcraft flying mostly in sustained autorotation, but with the rotor powered in flight at selected sections of the flight profile. In contrast, gyroplanes may be defined as rotorcraft always flying in sustained autorotation with the rotor never powered in flight. During prerotation, rotors of gyrodynes and gyroplanes may be powered by a reaction drive system. In certain sections of a flight profile, rotors of gyrodynes may also be powered in flight by a reaction drive system.

In selected embodiments, a reaction drive system may include one or more ducts conducting compressed air from one or more air compressors through a rotor hub and rotor blades to nozzles or tip jet engines mounted proximate the ends or tips of the rotor blades. A rotor may be driven by compressed air only, which may provide adequate power for prerotation. However, compressed air alone may be insufficient to power a gyrodyne in hover or the like. A gyrodyne with a reaction drive system may thus be equipped with tip jets, which support combustion when fuel is added to the compressed air in a combustion chamber of the tip jet.

Compressed air traveling in a reaction drive system may be relatively hot. For example, the temperature of compressed air flowing within a reaction drive system may be as high as 1400 degrees Fahrenheit, depending on the compression ratio used. This heat may cause problems between components with different coefficients of thermal expansion. Additionally, the heat may accelerate wear, complicate lubrication, and the like between moving parts located within the flow of compressed air.

Accordingly, in selected embodiments, a rotorcraft may expose few, if any, moving parts to the flow of compressed air. For example, in certain embodiments, a mechanical control system (e.g., system for controlling collective and cyclic pitch of the rotor blades) may be positioned outside the flow of compressed air.

In selected embodiments, a rotorcraft in accordance with the present invention may include an airframe and one or more rotors. The airframe may include one or more masts for rotatably securing the one or more rotors. A mast may define an interior cavity, an axial direction, and a radial direction. The interior cavity of a mast may have an internal diameter and cross sectional area sufficient to accommodate rotor bearings and still permit the flow of compressed air to pass through the mast at an acceptable pressure loss. A mast may be secured to the rest of an airframe by a vibration dampening system. Ducting for the flow of compressed air may connect to the mast (e.g., connect on the bottom or side thereof).

A rotor may include a hub. A hub may be mounted on top of a mast and interface with the mast via roller or ball bearings. A hub may overlap with a mast sufficiently (e.g., only sufficiently) to accommodate the bearings and loads. In selected embodiments, a hub may include an axial conduit extending in the axial direction into the interior cavity of a corresponding mast. Main bearings may interface between the axial conduit and the mast. This may enable the hub to rotate with respect to the mast about an axis extending in the axial direction.

At least one rotor blade may be connected to each hub to extend away therefrom in the radial direction. A rotor blade in accordance with the present invention may include a radial conduit extending in the radial direction. A corresponding hub may include a blade portal for each blade extending from the hub.

A blade portal may provide a location or mount for securing a rotor blade to a corresponding hub. Alternatively, or in addition thereto, a blade portal may place the axial conduit of a hub in fluid communication with the radial conduit of a corresponding rotor blade. Accordingly, compressed air may be passed through the interior cavity of the mast, through the axial conduit and a blade portal of the hub, and into a radial conduit of a rotor blade from which it will be discharged.

In selected embodiments, a mechanical control system may include a swashplate assembly. A swashplate assembly may assist in communicating inputs or commands to one or more rotor blades extending from a hub. In selected embodiments, a swashplate assembly may encircle a mast exterior to the interior cavity thereof. For example, a mast may define or include a cylindrical exterior surface. A swashplate assembly may encircle and travel along the cylindrical exterior surface.

By positioning a swashplate assembly and other components of a mechanical control system exterior to the mast and hub, several benefits may be realized. For example, the mechanical control system may thereby not be subjected to large variations in temperature caused by the flow of compressed air through the interior of the mast and hub. As a result, standard bearings and lubrication systems may be used on the mechanical control system.

Additionally, the mechanical control system may be much easier to inspect and service, since it is not positioned as deeply within the rotorcraft. Moreover, the mechanical control system thereby need not interfere with (e.g., increase the pressure drop of) the flow of compressed air through the mast and hub. While a mechanical control system positioned external to the mast and hub may tend to increase the drag of the rotorcraft, this increase in drag may be minimized through the use of appropriate fairings.

In certain embodiments, a swashplate assembly may include a slider, fixed swashplate, gimbal ring, and rotating swashplate. A slider may encircle the mast and selectively slide up and down along the cylindrical exterior surface of a mast. A fixed swashplate may encircle the slider and be rotationally fixed with respect to the mast. A gimbal ring may encircle a slider and pivotably connect a fixed swashplate to the slider. A gimbal ring may support pivoting of the fixed swashplate with respect to the slider about two orthogonal axes.

A rotating swashplate may encircle a fixed swashplate. Swashplate bearings may interface between a rotating swashplate and a fixed swashplate. Accordingly, a rotating swashplate may rotate about or with respect to a fixed swashplate. One or more first linkages may connect a rotating swashplate to a corresponding hub. The first linkages may ensure that the rotating swashplate rotates with the hub. One or more second linkages may connect the rotating swashplate to each of the pitch arms of the various rotor blades corresponding to the hub.

During operation of selected embodiments, command inputs (e.g., displacements affecting collective or cyclic pitch) may be imposed on the fixed swashplate of a swashplate assembly. The fixed swashplate may communicate such commands to the rotating swashplate, which may pass them on to the one or more second linkages. The second linkages may then transmit the commands into the pitch arms of the various rotor blades. In this manner, the collective and cyclic pitch of the various rotor blades may be controlled.

In selected embodiments, the pitch arms of the various rotor blades may be located exterior to the hub and interior cavity of the mast. Similarly, the first and second linkages may be located exterior to the hub and interior cavity. Accordingly, the interior of a hub (e.g., axial conduit) may be vacant and dedicated substantially exclusively to the conduction of compressed air therethrough.

In certain embodiments, the flow of compressed air passing through a radial conduit formed within a rotor blade may be used to feed a tip jet. That is, the flow of compressed air may form an input to a small jet engine operating proximate the tip of a rotor blade. Alternatively, or in addition thereto (e.g., prior thereto), the compressed air may be used to prerotate a rotor.

For example, each rotor may include multiple rotor blades that each include a tip nozzle for powering prerotation. When prerotation is needed or desired, compressed air may be fed to the tip nozzle through a radial conduit formed within the corresponding rotor blade. This radial conduit may extend from the root to the tip of the rotor blade. A hub of a rotor may act as a manifold, feeding compressed air into the radial conduits of the various rotor blades.

In selected embodiments, a system in accordance with the present invention may include one or more air sources (e.g., generators of compressed air) and a duct system interconnecting the air sources and the tip nozzles. Suitable sources of compressed air may include any of exhaust gas from a jet engine, air bled from the compressor portion of a jet engine, air from the fan of a turbofan engine (i.e., bypass air), air compressed by a dedicated, single purpose engine or motor, and the like.

A source of compressed air may also include a turboprop engine driving a propeller on one side and a compressor on the other. In such an embodiment, the compressor may be connected to the engine via a clutch. When air from the compressor is no longer needed, the compressor may be disengaged from the engine. Accordingly, a rotorcraft in accordance with the present invention may be equipped with one or more engines providing thrust, compressed air for the tip nozzles, or both.

Rotorcraft utilizing one or more rotors prerotated by tip nozzles may generate substantially no torque between the rotor or rotors and the airframe. Accordingly, a compressed air prerotation system in accordance with the present invention may be utilized during take-off (e.g., after the aircraft is in flight). This may provide improved take-off performance.

Additionally, unlike current systems, rotorcraft in accordance with the present invention may not require complex and heavy transmissions and interconnecting drive shafts, hydraulic pumps, motors, or the like. Instead, they may typically include simple, light ducting. Accordingly, rotorcraft in accordance with the present invention may include a prerotation system that is less complex, easier to maintain, and lighter in weight.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of a rotorcraft in accordance with one embodiment of the present invention, the rotorcraft having two engines and one rotor;

FIG. 2 is a schematic front elevation view of a compressed or otherwise pressurized air supply for tip jets in accordance with one embodiment of the present invention;

FIG. 3A is a front elevation view of a rotorcraft illustrating operational parameters describing a rotor configuration suitable for use in accordance with the present invention and the system of FIGS. 1 and 2 in particular;

FIG. 3B is a right side elevation view of the rotorcraft of FIG. 3A;

FIG. 3C is a partial cut of a right side elevation view of the rotor of FIG. 3A;

FIG. 4 is a schematic diagram illustrating one embodiment of a compressed air system in accordance with the present invention;

FIG. 5 is a schematic diagram illustrating an alternative embodiment of a compressed air system in accordance with the present invention;

FIG. 6 is a schematic diagram illustrating one embodiment of a method for prerotation by compressed air in accordance with the present invention;

FIG. 7 is a top plan view of one embodiment of a rotor in accordance with the present invention;

FIG. 8 is a first side elevation cross-sectional view of the rotor of FIG. 7;

FIG. 9 is a second side elevation cross-sectional view of the rotor of FIG. 7;

FIG. 10 is a perspective view of the hub, mast, swashplate assembly, and first and second linkages of the rotor of FIG. 7; and

FIG. 11 is a partially cut-away view of one embodiment of a rotor blade tip and tip nozzle in accordance with the present invention.

### DETAILED DESCRIPTION OF SELECTED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

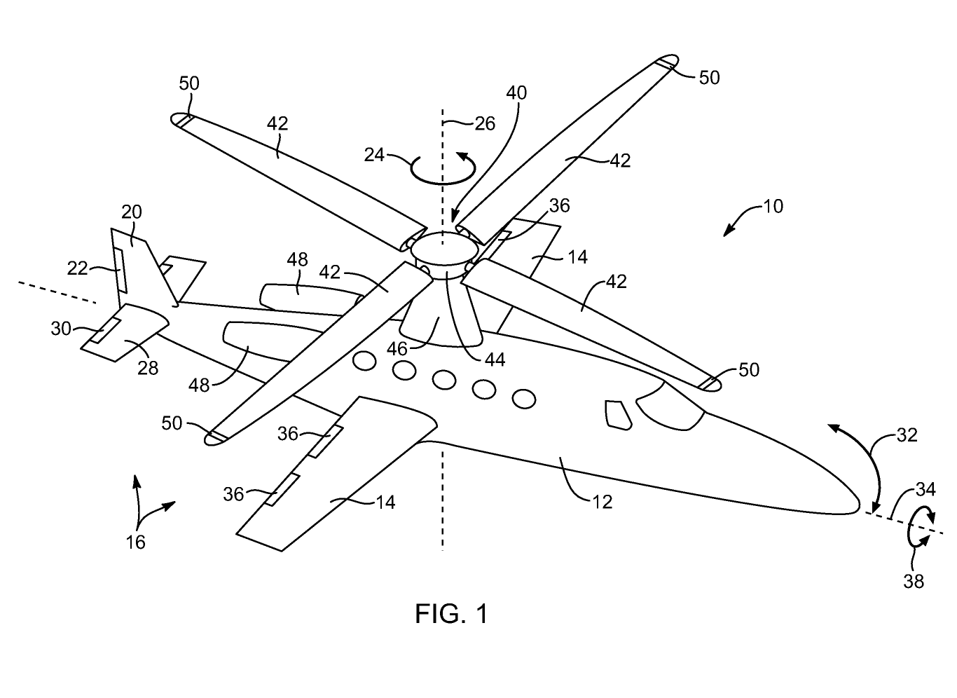

Referring to FIG. 1, a rotorcraft 10 in accordance with the present invention may include an airframe 12 defining a cabin for carrying an operator, passengers, cargo, or the like. The airframe 12 may include one or more fixed wings 14 or airfoils 14 providing lift to the rotorcraft 10. The wings 14 may be configured such that they provide sufficient lift to overcome the weight of the rotorcraft 10 (or any significant portion thereof) only at comparatively high speeds.

That is, a rotorcraft 10 may be capable of vertical takeoff and landing (VTOL) and may not need lift from the fixed wings 14 at low speeds (e.g., below 50 mph or even 100 mph). Accordingly, the wings 14 may be made smaller than those of fixed-wing aircraft requiring a high velocity takeoff. The smaller wings 14 may result in lower drag at higher velocities. In some embodiments, the wings 14 may provide sufficient lift to support at least 50 percent, preferably about 90 percent, of the weight of the rotorcraft 10 at air speeds above 200 mph.

Control surfaces 16 may form part of an airframe 12. For example a tail structure 18 may include one or more vertical stabilizers 20 and one or more rudders 22. The rudders 22 may be adjustable to control yaw 24 of the rotorcraft 10 during flight. As known in the art, yaw 24 is defined as rotation about a vertical axis 26 of the rotorcraft 10. In the illustrated embodiment, the rudders 22 may comprise hinged portions of the vertical stabilizers 20.

The tail structure 18 may further include a horizontal stabilizer 28 and an elevator 30. The elevator 30 may be adjustable to alter pitch 32 of the rotorcraft 10. As known in the art, pitch 32 is defined as rotation about an axis extending laterally with respect to the airframe 10. In the illustrated embodiment, the elevator 30 is a hinged portion of the horizontal stabilizer 28. In some embodiments, twin rudders 22 may be positioned at an angle relative to the vertical axis 26 and serve both to adjust or control yaw 24 and pitch 32 of the rotorcraft 10.

The control surfaces 16 may also include ailerons 36 on the wings 14. Ailerons 36 may be used to control roll 38 of the rotorcraft 10. As known in the art, roll 38 is defined as rotation about the longitudinal axis 34 of the rotorcraft 10.

Lift during vertical takeoff and landing, and for augmenting lift of the wings 14 during flight, may be provided by a rotor 40. A rotor 40 may comprise a number of individual rotor blades 42 extending radially away from a hub 44. The hub 44 may be coupled to a mast 46. The mast may extend to connect the hub 44 to the rest of the airframe 12.

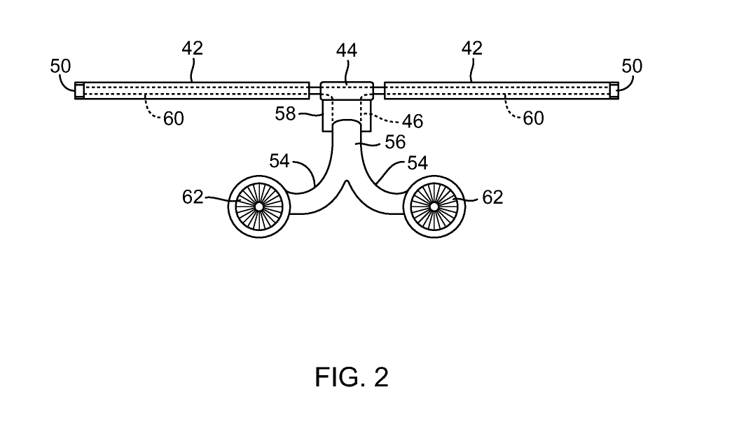

Referring to FIG. 2, a rotor 40 may be coupled to one or more engines 48 housed in a fuselage portion of the airframe 12 or in one or more adjacent nacelles. The engines 48 may provide thrust during flight of the rotorcraft 10. The engines 48 may also generate compressed air for the tip jets 50 or nozzles 50.

For example, in selected embodiments, the engines 48 may comprise one or more bypass turbines 62. All or a portion of the bypass air from the turbines 62 may be directed to the tip jets 50 or nozzles 50. Alternatively, the engines 48 may drive one or more auxiliary compressors, which in turn may provide the compressed air for the tip jets 50 or nozzles 50. In still other embodiments, all or a portion of the compressed air may be generated by one or more dedicated, single purpose engines, motors, or the like. Using the compressed air, the tip jets 50 or nozzles 50 may power the rotor 40 during prerotation, takeoff, landing, hover, or whenever the flight speed of the rotorcraft 10 is too low for sufficient lift from autorotation of the rotor 40.

In selected embodiments, the compressed air generated by the engines 48 may be conducted to the tip jets 50 or nozzles 50 via one or more conduits or ducts 54, 55. For example, bypass air from one or more bypass turbines 62 may be transmitted through ducts 54 to a plenum 56. The plenum 56 may be in fluid communication via ducting 55 with a mast 46 that is hollow or has another passage to provide for air conduction. For example, a mast fairing 58 positioned around the mast 46 may provide one or both of an air channel and a low drag profile for the mast 46. The mast 46 or mast fairing 58 may be in fluid communication with a hub 44. Finally, the hub 44 may be in fluid communication with an interior, radial conduit 60 within each of the various rotor blades 42. Accordingly, the compressed air may travel radially within the interior, radial conduits 60 to feed the corresponding tip jets 50 or nozzles 50.

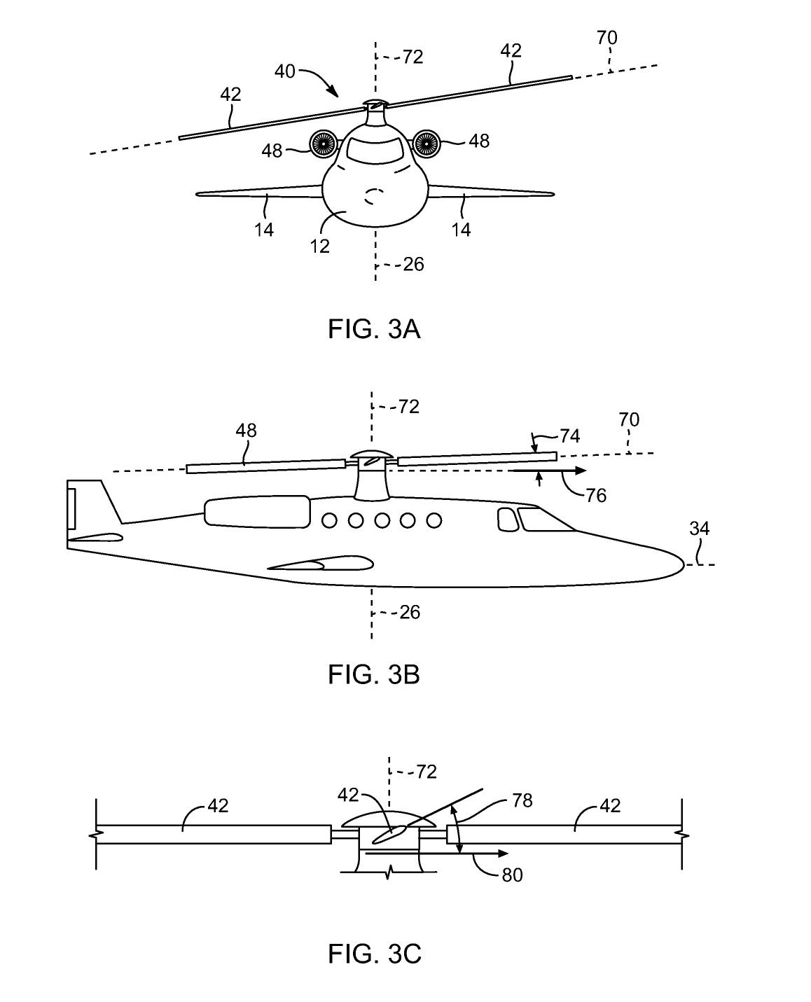

Referring to FIGS. 3A-3C, rotation of the rotor 40 about its axis of rotation occurs in a rotor disc 70 that is generally planar but may be contoured due to flexing of the blades 42. In general, the rotor disc 70 may be defined as a space in which the tips of the blades 42 travel. Inasmuch as the blades 42 flap cyclically upward and downward due to changes in lift while advancing and retreating, the rotor disc 70 may be angled or contoured with respect to the axis of rotation when viewed along the longitudinal axis 34, as shown in FIG. 3A.

Referring to FIG. 3B, the angle 74 of the rotor disc 70, relative to a flight direction 76 in the plane containing the longitudinal axis 34 and vertical axis 26, is defined as the rotor angle of attack 74 or rotor disk angle of attack 74. For purposes of this application, flight direction 76 and air speed refer to the direction and speed, respectively, of the airframe 12 of the rotorcraft 10 relative to surrounding air. In autogyro systems, the angle of attack 74 of the rotor disc 70 is generally positive in order to achieve autorotation of the rotor 40 and the resulting lift.

Referring to FIG. 3C, the surfaces of the rotor blades 42, and particularly the chord of each blade 42, define a pitch angle 78, or blade angle of attack 78, relative to the direction of movement 80 of the rotor blades 42. In general, a higher pitch angle 78 will result in more lift and higher drag on the rotor blade 42, up to the point where stalling occurs (at which point lift has declined below a value necessary to sustain flight). The pitch angle 78 of the rotor blade 42 may be manipulated by both cyclic and collective pitch controls.

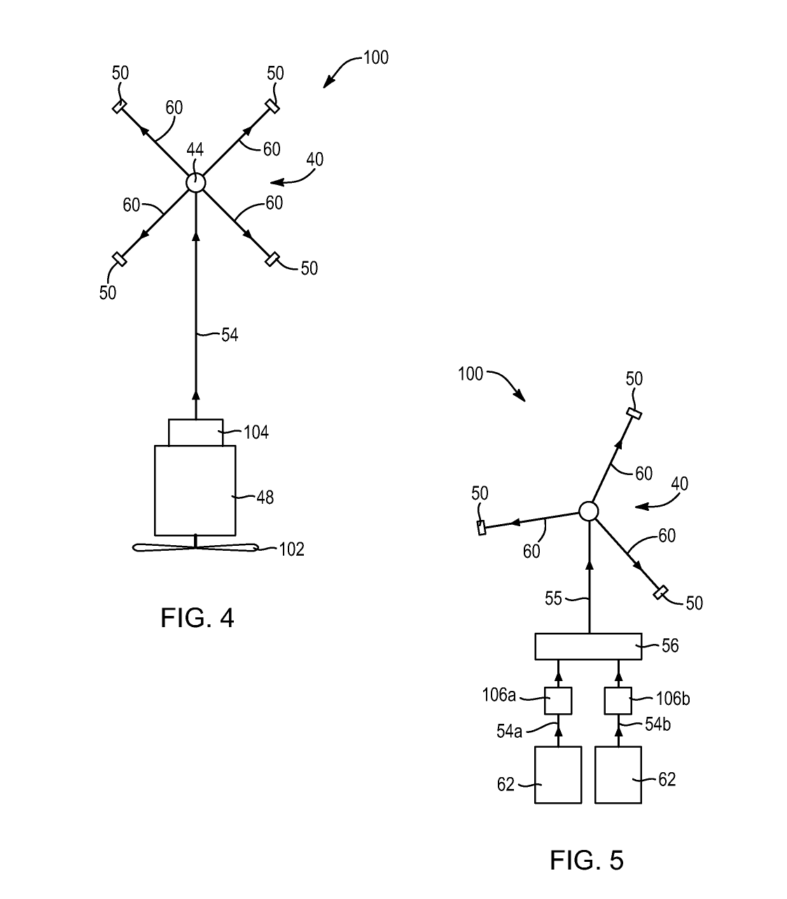

Referring to FIG. 4, in selected embodiments, a reaction drive system may include a compressed air system 100. A compressed air system 100 in accordance with the present invention may include one or more sources or generators of compressed air. For example, a rotorcraft 10 may include one or more engines 48 generating forward thrust. One or more of the engines 48 may also generate compressed air. Accordingly, one or more of the engines 48 may be considered an air source or compressor.

An engine 48 may generate compressed air in any suitable manner. For example, a jet engine may generate exhaust gases. A portion of the exhaust gases may be collected or diverted as compressed air into a compressed air system 100. Alternatively, air may be bled from the compressor portion of a jet engine to form a flow of compressed air.

In other embodiments, an engine 48 may comprise a turbofan engine 62. Air from the fan of the turbofan engine 62 (i.e., the bypass air) may be collected or diverted as compressed air into a compressed air system 100. In still other embodiments, a flow of compressed air may be generated by one or more dedicated engines or motors whose sole purpose is not to generate thrust in the direction 76 of flight, but rather to generate compressed air for the tip jets 50 or nozzles 50.

In the illustrated embodiment, the compressed air system 100 comprises a single turboprop engine 48. The engine 48 drives a propeller 102 on one side and a compressor 104 on the other. In such an embodiment, the compressor 104 may be connected to the engine 48 via a clutch. When air from the compressor 104 is no longer needed, the compressor 104 may be disengaged from the engine 48. Accordingly, a rotorcraft 10 in accordance with the present invention may be equipped with one or more engines 48 providing both thrust in the direction 76 of flight and compressed air for the tip jets 50 or nozzles 50.

Referring to FIG. 5, a compressed air system 100 in accordance with the present invention may include a network of conduits interconnecting each source of compressed air with each tip jet 50 or nozzle 50. In selected embodiments, any air source may provide compressed air to any tip jet 50 or nozzle 50. The network may include one or more outlets corresponding to each of the sources of compressed air. Compressed air may leave each source through such an outlet. An incoming conduit 54 may then conduct compressed air from the outlet to the plenum 56. In the illustrated embodiment, one incoming conduit 54a, 54b is dedicated to each of the two sources of compressed air.

A plenum 56 in accordance with the present invention may have any suitable configuration. A plenum 56 may be situated within a rotorcraft 10 to optimize the flow of compressed air from one or more sources to one or more rotors 40. In selected embodiments, a plenum 56 may include or define a volume sufficiently large such that the pressure drop imposed thereby is sufficiently small as to be insignificant. Accordingly, the interior dimensions of a plenum 56 may be greater (e.g., significantly greater) than those of the individual incoming conduits 54. Additionally, a plenum 56 may be larger, both in length and girth, for larger rotorcraft 10.

Compressed air may exit a plenum 56 via one or more outgoing conduits 55. The outgoing conduits 55 may conduct compressed air from the plenum 56 to the various rotors 40. In the illustrated embodiment, one outgoing conduit 55 is dedicated to a single rotor 40. Within each rotor 40, the compressed air may be delivered to the hub 44. The hub 44 of a rotor 40 may act as a manifold, feeding compressed air into the radial conduits 60 of the various rotor blades 42.

A compressed air system 100 may include a control subsystem. A control subsystem may selectively control operation of a compressed air system 100. For example, a control subsystem may enable a pilot to turn the flow of compressed air to the tip jets 50 or nozzles 50 “on” or “off.” In selected embodiments, a control subsystem may include a clutch for selectively disengaging a compressor 104 from an engine 48. Alternatively or in addition thereto, a control subsystem may include various valves 106 controlling airflow from an air source.

For example, in the illustrated embodiment, a valve 106a, 106b of a control subsystem may be positioned within each of the incoming conduits 54a, 54b. When the valves 106 are closed, no compressed air may flow from a source (e.g., turbofan engine 62) to the tip jets 50 or nozzles 50. Additionally, the valves 106 may control the power of a prerotation system 100 by controlling the mass of air flowing out of the tip jets 50 or nozzles 50.

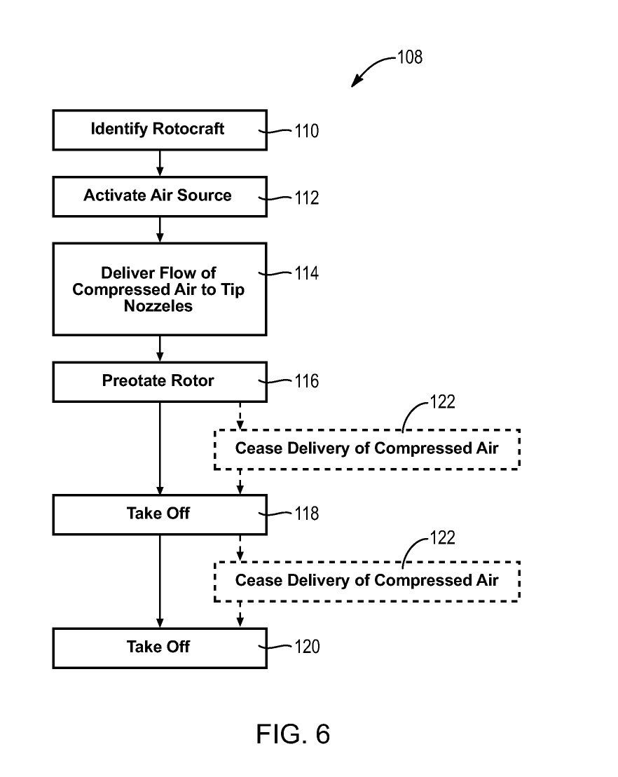

Referring to FIG. 6, a prerotation method 108 in accordance with the present invention may begin with identification 110 or selection of a rotorcraft 10. When a pilot desires to fly the rotorcraft 10, one or more sources of compressed air may be activated 112. Once activated 112, the sources of compressed air may deliver 114 a flow of compressed air to one or more (e.g., each) of the tip nozzles 50 of the rotorcraft 10.

Compressed air exiting a tip nozzle 50 may produce a reactive force urging rotation of the rotor 40. Accordingly, the flow of compressed air exiting the various tip nozzles 50 may prerotate 116 the rotor 40 of the rotorcraft 10. In selected embodiments, rotors 40 having blades 42 with a fixed blade pitch may be prerotated 116 (i.e., spun-up 116) by a prerotation system 100 in accordance with the present invention, typically to about 60 percent to 70 percent of the rotor's operational RPM. Rotors 40 having blades with pitch adjustment (e.g., full collective adjustment) may be prerotated 116 by a prerotation system 100 in accordance with the present invention up to about 140 percent of operational RPM.

Once prerotation 116 is complete, the rotorcraft 10 may take off 118. The prerotation 116 may significantly reduce the rolling distance required for take off 118 of the rotorcraft 10. For example, prerotated rotorcraft 10 (e.g., gyroplanes) with fixed pitch rotors (e.g., those classified by the FAA as “experimental” or “light sport aircraft”) may have a take-off roll of about 100 yards or more. Prerotated rotorcraft 10 (e.g., gyroplanes) with collective pitch adjustment may have a take-off roll from zero (jump-take-off) to about 10 yards (ultra-short take-off). After take off 118, a rotorcraft 10 may be flown 120 as desired.

In certain embodiments, both prerotation 116 and take off 118 may be accomplished without adding fuel to the flow of compressed air. That is, prerotation 116 and take off 118 may be accomplished without using the flow of compressed air as an input to a jet engine (e.g., an operating tip jet 50). Accordingly, the flow of compressed air may simply vent through a tip nozzle 50 or non-operating (e.g., non-burning) tip jet 50.

In selected embodiments, the flow of compressed air may cease 122 (e.g., be terminated 122) sometime after prerotation 116 is complete. For example, in certain embodiments or situations, the flow of compressed air to the one or more tip nozzles 50 may be terminated 122 after prerotation 116 and before take off 118. Alternatively, in other embodiments or situations, the flow of compressed air to the one or more tip nozzles 50 may be terminated 122 sometime after take off 118 (e.g., upon reaching a particular altitude, air speed, autorotation, or the like). Accordingly, a compressed air system 100 in accordance with the present invention may provide improved performance at take off 118, during flight 120, or some combination thereof.

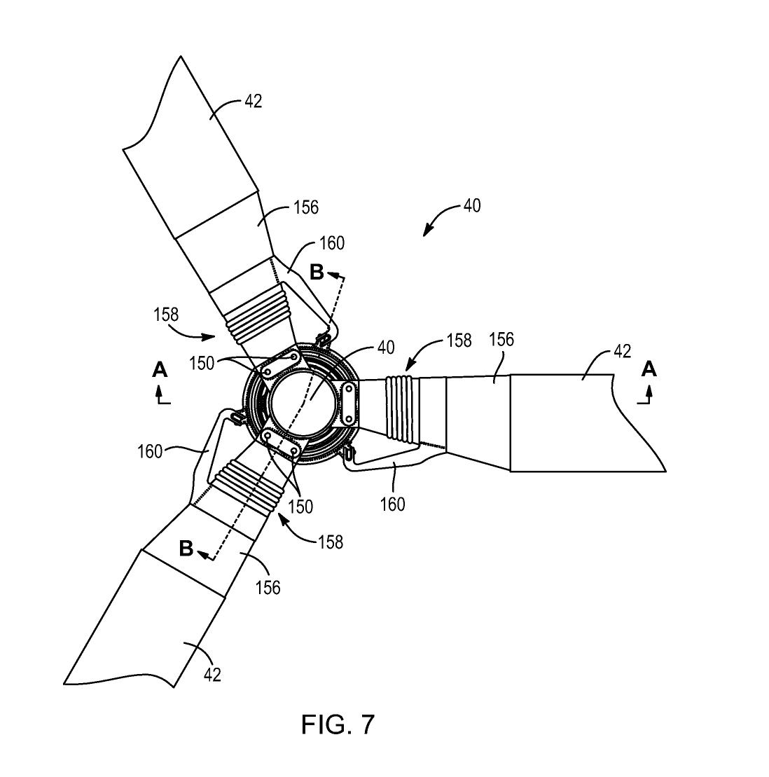

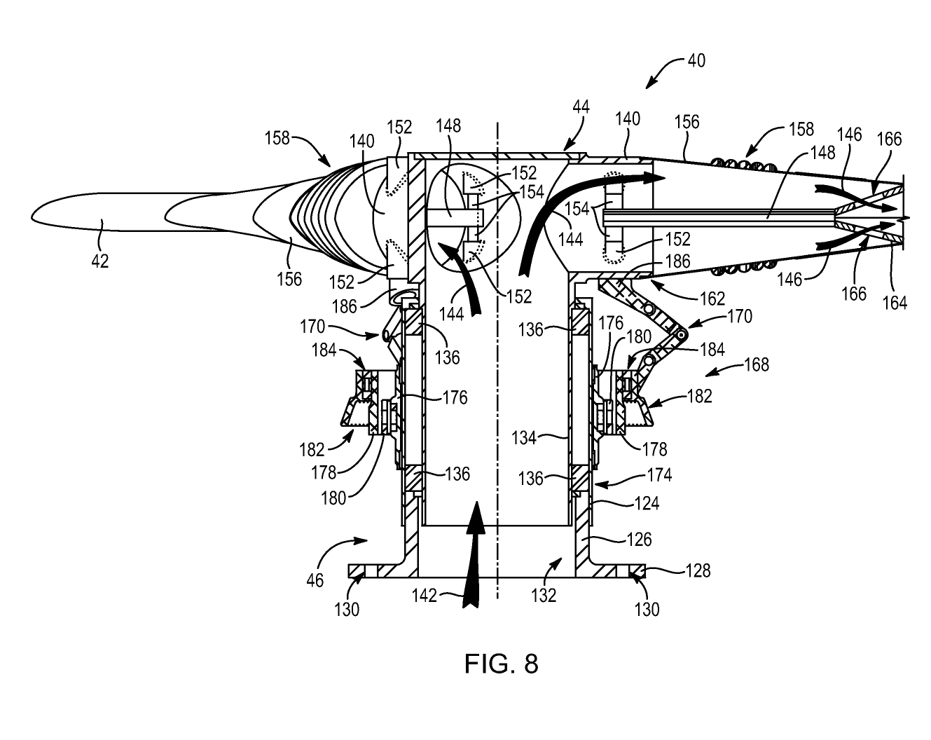

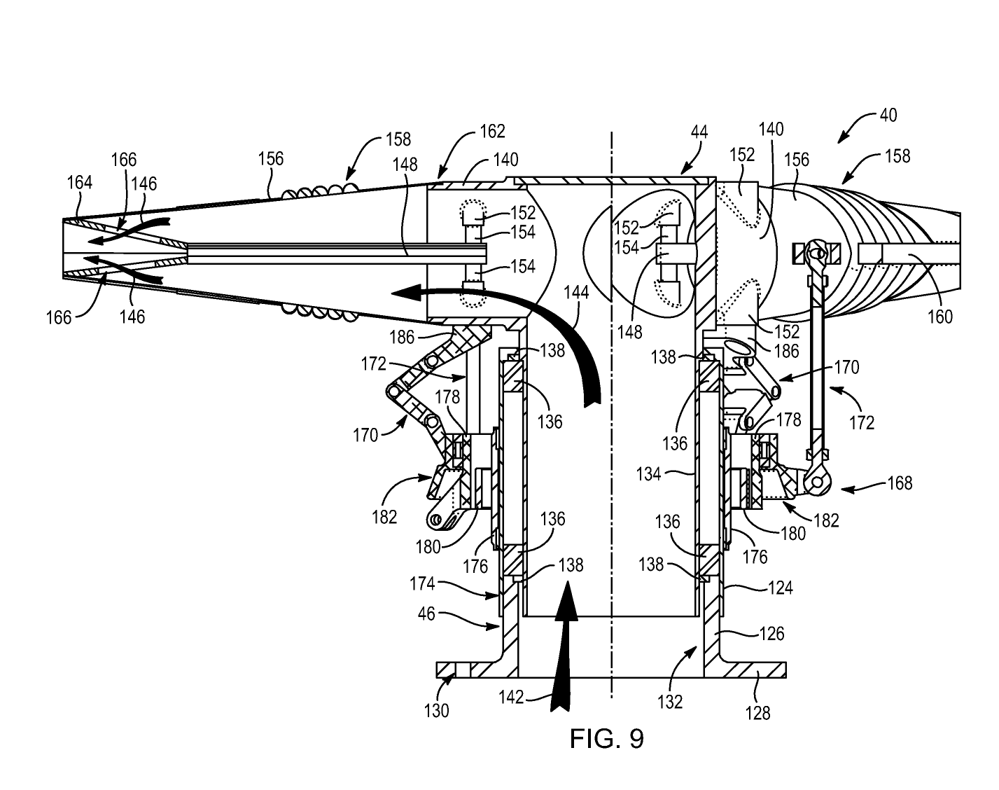

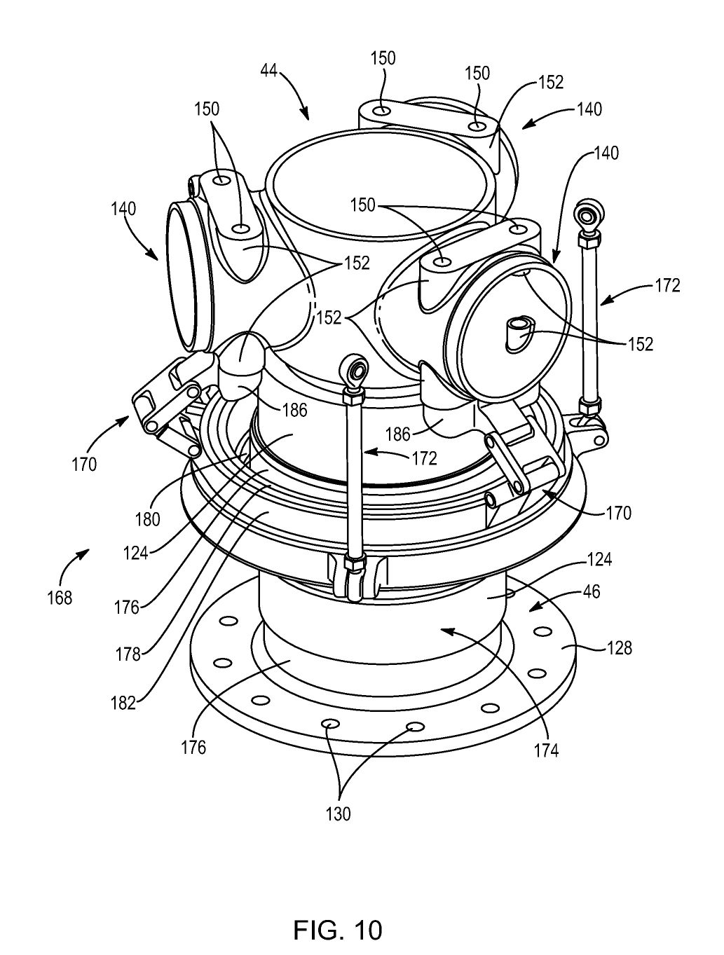

Referring to FIGS. 7-10, in selected embodiments, an airframe 12 in accordance with the present invention may include a mast 46. A mast 46 may form an interface between the rest of an airframe 12 and a rotor 40. In certain embodiments, a mast 46 may include an upper portion 124 and a base 126. A base 126 may include a mounting flange 128 with apertures 130 facilitating securement (e.g., bolting) of the mast 46 to the rest of an airframe 12.

A mast 46 may define an interior cavity 132 extending in the axial direction therethrough. In selected embodiments, a hub 44 may include an axial conduit 134 extending in the axial direction into the interior cavity 132 of a mast 46. Main bearings 136 and seals 138 may interface between the axial conduit 134 and the mast 46. For example, an upper portion 124 and base 126 of a mast 46 may include or have an interior surface defining the interior cavity 132. The axial conduit 134 may include or have an exterior surface. Accordingly, in selected embodiments, the main bearings 136 and seals 138 may interface between the exterior surface of the axial conduit 134 and the interior surface of the mast 46. This may enable the hub 44 to rotate with respect to the mast 46 about an axis extending in the axial direction.

A hub 46 in accordance with the present invention may include a blade portal 140 corresponding to each rotor blade 42 connected to the hub 46. A blade portal 140 may provide a location or mount for securing a rotor blade 42 to a corresponding hub 44. Alternatively, or in addition thereto, a blade portal 140 may place the axial conduit 134 (i.e., the interior of the axial conduit 134) of a hub 44 in fluid communication with the radial conduit 60 of a corresponding rotor blade 42. Accordingly, a flow of compressed air from a compressed air system 100 may pass through 142 the interior cavity 132 of the mast 46, through 142 the axial conduit 134 of a hub 44, through 144 a blade portal 140 of the hub 44, and into 146 a radial conduit 60 of a rotor blade 42.

A rotor blade 42 in accordance with the present invention may connect to a blade portal 140 in any suitable manner. In selected embodiments, the root of a rotor blade 42 may comprise a flex beam 148. A flex beam 148 may be thinner and narrower than the lifting portion of the rotor blade 42 (i.e., the portion producing lift during rotation). This smaller size, together with the choice of material for the flex beam 148, may enable or support flexing of the flex beam 148. The flexing may accommodate flapping of the rotor blade 42. The flexing may also accommodate adjustments to the pitch of the rotor blade 42. Additionally, the smaller size may enable the flex beam 148 to extend into the interior of a blade portal 140 where it may be bolted in place.

In selected embodiments, apertures 150 extending in the axial direction through a blade portal 140 may provide a location for fasteners (e.g., bolts) to penetrate and secure a flex beam 148. The apertures 150 may be defined by or extend through one or more interior or exterior adapters 152. An adapter 152 may be monolithically formed within the wall of a blade portal 140. An adapter 152 may reinforce or strengthen the boundaries of the apertures 150 passing therethrough. An adapter 152 may also provide a flat surface for abutting against the head of a fastener, an adjacent spacer 154 or collar 154, or some other neighboring component.

In certain embodiments, a flex beam 148 may be secured within a blade portal 140 by two fasteners extending in the axial direction. Each fastener may pass through corresponding apertures 150 in corresponding adapters 152 and penetrate the flex beam 148. In selected embodiments, the flex beam 148 may be centered between opposing adapters 152 by two or more spacers 154 or collars 154 encircling the fastener (e.g., penetrated by the fastener).

The flex beam 148 portion of a rotor blade 42 may be covered by a transition member 156. A transition member 156 may form an aerodynamic transition from a blade portal 140 to the lifting portion of a rotor blade 42. In certain embodiments, a transition member 156 may include various corrugations 158, formed like a bellows 158 or an accordion section 158, enabling the transition member 156 to perform its function while accommodating flexing or relative motion between the rest of the rotor blade 42 and the hub 44.

A transition member 156 may include a pitch arm 160 extending therefrom. Deflections imposed on a pitch arm 160 may be communicated through the transition member 156 and into the rest of the rotor blade 42. In this manner, adjustments may be made to the pitch of the rotor blade 42. In selected embodiments, the interface 162 between a transition member 156 and a blade portal 140 may support relative rotation therebetween about an axis extending in the radial direction. Accordingly, the transition member 156 may rotate with respect to the hub 44 during changes in pitch of the rest of the rotor blade 42.

In selected embodiments, a flex beam 148 may provide the primary structural connection between a hub 44 and a rotor blade 42. In such embodiments, the flow of compressed air passing through 144 a blade portal 140 may travel around (e.g., external to) the flex beam 148. A transition member 156 may form the barrier between the flow of compressed air and the surrounding atmosphere. Additionally, the transition member 156 may tend to funnel or otherwise direct the flow of compressed air into the radial conduit 60 of the lifting portion of the rotor blade 42.

As the flow of compressed air nears the radial conduit 60 of the lifting portion of the rotor blade 42, it may pass 146 through a transition. For example, an adapter 164 may form the interface between a flex beam 148 and the lifting portion of the rotor blade 42. Accordingly, to reach the radial conduit 60 of the lifting portion of the rotor blade 42, the flow of compressed air may pass 146 through the adapter 164. Apertures 166 of sufficient size and quantity may be formed in an adapter 164 to enable this passage 146.

In selected alternative embodiments, a flex beam 148 may be omitted and a hollow spindle forming the root of the rotor blade 42 may provide the primary structural connection between a hub 44 and a rotor blade 42. In such embodiments, the flow of compressed air passing through 144 a blade portal 140 may travel directly into the hollow spindle. The hollow spindle may form a barrier between the flow of compressed air and the surrounding atmosphere. Additionally, the hollow spindle may tend to funnel or otherwise direct the flow of compressed air into the radial conduit 60 of the lifting portion of the rotor blade 42.

A swashplate assembly 168 may combine with various linkages 170, 172 to communicate inputs or commands to one or more rotor blades 42 extending from a hub 44. In selected embodiments, a swashplate assembly 168 may encircle a mast 46 exterior to the interior cavity 132. For example, a mast 46 may define or include a cylindrical exterior surface 174. A swashplate assembly 168 may encircle and travel along the cylindrical exterior surface 174.

In certain embodiments, a swashplate assembly 168 may include a slider 176, fixed swashplate 178, gimbal ring 180, and rotating swashplate 182. A slider 176 may encircle the mast 46 and, with one or more bushings, selectively slide up and down in the axial direction along the cylindrical exterior surface 174 of a mast 46. A fixed swashplate 178 may encircle the slider 176 and be rotationally fixed with respect to the mast 46. A gimbal ring 180 may encircle a slider 176 and pivotably connect the fixed swashplate 178 to the slider 176. A gimbal ring 180 may support pivoting of the fixed swashplate 178 with respect to the slider 176 about two orthogonal axes.

A rotating swashplate 182 may encircle a fixed swashplate 178. Swashplate bearings 184 may interface between a rotating swashplate 182 and fixed swashplate 178. Accordingly, a rotating swashplate 182 may rotate about or with respect to a fixed swashplate 178. One or more first linkages 170 may connect a rotating swashplate 182 to a corresponding hub 44. The first linkages 170 may ensure that the rotating swashplate 182 rotates with the hub 44, even while the axial distance between the rotating swashplate 182 and the hub 44 may change.

In selected embodiments, upper links 186 of the first linkages 170 may abut one or more flat surfaces of the adapters 152 located on the underside of the blade portals 140. In such embodiments, the fasteners securing a flex beam 148 may also secure the upper links of the first linkages 170 in place.

One or more second linkages 172 may connect the rotating swashplate 182 to each of the pitch arms 160 of the various rotor blades 42 corresponding to the hub 44. The number of second linkages 172 may match the number of rotor blades 42. During operation of selected embodiments, command inputs (e.g., displacements affecting collective or cyclic pitch) may be imposed on the fixed swashplate 178 of a swashplate assembly 168. The fixed swashplate 178 may communicate such commands to the rotating swashplate 182, which may pass them on to the one or more second linkages 172. The second linkages 172 may then transmit the commands into the pitch arms 160 of the various rotor blades 42. In this manner, the collective and cyclic pitch of the various rotor blades 42 may be controlled.

In selected embodiments, the pitch arms 160 of the various rotor blades 42 may be located exterior to the hub 44 and interior cavity 132 of the mast 46. Similarly, the first and second linkages 170, 172 may be located exterior to the hub 44 and interior cavity 132. Accordingly, the interior of a hub 44 (e.g., the interior of an axial conduit 134) may be vacant and dedicated substantially exclusively to the conduction of compressed air therethrough.

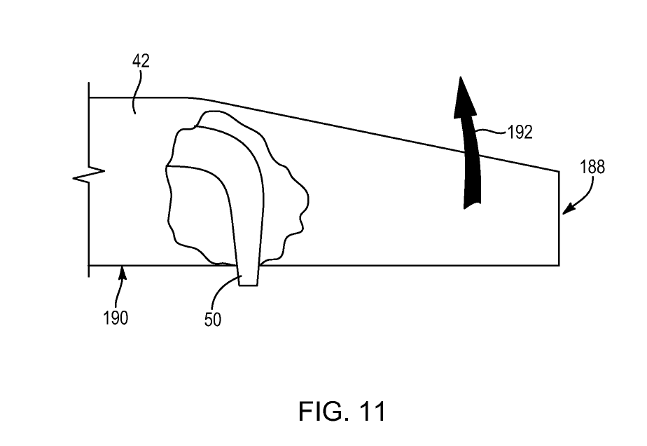

Referring to FIG. 11, in certain embodiments, the flow of compressed air passing through a radial conduit 60 formed within a rotor blade 42 may be used to feed a tip jet 50 or tip nozzle 50. For example, the flow of compressed air may form an input to a small jet engine operating proximate the tip 188 of a rotor blade 42 (i.e., a tip jet 50). In such embodiments, fuel may be added to the flow of compressed air within the tip jet 50. When the fuel is burned within the tip jet 50, the gas expansion and resulting thrust produced may be significantly greater that the reactive force that would have been produced had the compressed air been simply vented or nozzled out the trailing edge 180 of the rotor blade 42. A rotorcraft 10 with tip jets 50 may operate as a gyrodyne, supporting vertical take-off, landing, and hover.

Alternatively, or in addition thereto (e.g., prior thereto), a flow of compressed air may be used to prerotate a rotor 40. In such embodiments, a flow of compressed air exiting a tip nozzle 50 may product a reactive force 192 urging rotation of the rotor 40. In selected embodiments, a tip nozzle 50 may be specifically adapted to the flow compressed air. For example, a tip nozzle 50 may be a subsonic nozzle 50, a nozzle having no combustion chamber, or some combination thereof. This may reduce the noise produced during prerotation or other use of a compressed air system 100. Alternatively, a tip nozzle 50 may be a non-operating tip jet 50. That is, a tip nozzle 50 may comprise a tip jet 50 that is not adding or burning fuel therewithin.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A rotorcraft comprising:
an airframe comprising a mast defining an interior cavity;
at least one compressor connected to the airframe;
a rotor comprising
a hub connected to the mast to rotate with respect thereto, the hub defining an interior cavity, and
a rotor blade having a root and a tip and forming a radial conduit extending radially from the root toward the tip, the rotor blade connected to the hub;
a flow of compressed air generated by the at least one compressor and passing from the at least one compressor, through the interior cavity defined by the mast, through the interior cavity defined by the hub, and into the radial conduit; and
a swashplate assembly controlling pitch of the rotor blade, the swashplate assembly located exterior to the hub and mast.

2. The rotorcraft of claim 1, further comprising a first linkage extending to connect the swashplate assembly to the hub, the first linkage located exterior to the hub and mast.

3. The rotorcraft of claim 2, further comprising a second linkage extending to connect the swashplate assembly to the rotor blade, the second linkage located exterior to the hub and mast.

4. The rotorcraft of claim 3, wherein the mast comprises a cylindrical exterior surface.

5. The rotorcraft of claim 4, wherein the swashplate assembly encircles and travels along the cylindrical exterior surface of the mast.

6. The rotorcraft of claim 5, wherein the hub comprises an axial conduit extending axially into the interior cavity of the mast.

7. The rotorcraft of claim 6, wherein the hub further comprises a blade portal securing the rotor blade and placing the interior cavity of the hub in fluid communication with the radial conduit.

8. The rotorcraft of claim 1, wherein:
the rotor further comprises one of a tip jet and a tip nozzle secured proximate the tip;
the radial conduit extends from the root to the one of the tip jet and the tip nozzle; and
the flow of compressed air further passes through the radial conduit to the one of the tip jet and the tip nozzle.

9. The rotorcraft of claim 8, wherein the rotorcraft is a gyroplane.

10. The rotorcraft of claim 1, wherein the at least one compressor comprises at least one jet engine.

11. The rotorcraft of claim 10, wherein the flow of compressed air comprises exhaust gas from the at least one jet engine.

12. The rotorcraft of claim 10, wherein the flow of compressed air comprises air bled from a compressor portion of the at least one jet engine.

13. The rotorcraft of claim 10, wherein:
the at least one jet engine comprises a turbofan; and
the flow of compressed air comprises air from the fan of the turbofan.

14. The rotorcraft of claim 13, wherein the flow of compressed air comprises substantially all of the air from the fan of the turbofan.

15. A rotorcraft comprising:
an airframe comprising a mast, the mast having a cylindrical exterior surface and defining an interior cavity;
at least one compressor connected to the airframe;
a rotor comprising
a hub connected to the mast to rotate with respect thereto, the hub defining an interior cavity and comprising an axial conduit extending axially into the interior cavity of the mast, and a rotor blade having a root and a tip and forming a radial conduit extending radially from the root toward the tip, the rotor blade connected to the hub;
a flow of compressed air generated by the at least one compressor and passing from the at least one compressor, through the interior cavity defined by the mast, through the interior cavity defined by the hub, and into the radial conduit; and
a swashplate assembly controlling pitch of the rotor blade, the swashplate assembly encircling and traveling along the cylindrical exterior surface of the mast.

16. The rotorcraft of claim 15, further comprising a first linkage extending to connect the swashplate assembly to the hub, the first linkage located exterior to the hub and mast.

17. The rotorcraft of claim 16, further comprising a second linkage extending to connect the swashplate assembly to the rotor blade, the second linkage located exterior to the hub and mast.

18. A method comprising:
obtaining an airframe comprising a mast defining an interior cavity;
connecting at least one compressor to the airframe;
obtaining a rotor comprising
a hub defining an interior cavity, and
a rotor blade having a root and a tip and forming a radial conduit extending radially from the root toward the tip, the rotor blade connected to the hub;
defining a flow path enabling a flow of compressed air generated by the at least one compression to travel through the interior cavity defined by the mast, through the interior cavity defined by the hub, and into the radial conduit; and
securing a swashplate assembly to the airframe such that the swashplate assembly is outside the flow path.

19. The rotorcraft of claim 18, further comprising installing a first linkage connecting the swashplate assembly to the hub such that the first linkage is outside the flow path.

20. The rotorcraft of claim 19, further comprising installing a second linkage connecting the swashplate assembly to the rotor blade such that the second linkage is outside the flow path.
